(19) United States
(12) Patent Application Publication
(10) Pub. No.: US 2016/0061368 A1
(43) Pub. Date: Mar. 3, 2016

(54) HOSE COUPLING WITH SWIVEL JOINT

(71) Applicant: CATERPILLAR INC., Peoria, IL (US)

(72) Inventors: James Roger Carlberg, Peoria, IL (US); David Gordon Kupper, Edelstein, IL (US)

(73) Assignee: CATERPILLAR INC., Peoria, IL (US)

(21) Appl. No.: 14/471,844

(22) Filed: Aug. 28, 2014

(51) Int. Cl. F16L 27/02; B29C 45/14; F16L 13/14

(52) U.S. Cl. CPC F16L 27/023; F16L 13/141; B29C 45/14; B29C 45/14065; B29K 2075/00

(57) ABSTRACT

Disclosed are various exemplary embodiments of a hose coupling and hose assembly. The hose coupling may include a hose fitting member configured to sealingly engage with a first fluid communication member, a swivel joint comprising a swivel ball seated in a ball bearing, and a tube extending from the hose fitting member to the swivel ball. In some exemplary embodiments, the swivel ball may be configured to swivel inside the ball bearing to allow the tube to rotate with respect to a center of the swivel ball.

### TECHNICAL FIELD

The present disclosure relates generally to hydraulic connectors and, more particularly, to a hydraulic hose coupling for joining two fluid communication members.

### BACKGROUND

A hose coupling is a hydraulic connector for connecting a hose or fitting to another hose or fitting to enable fluid communication therebetween. There are many different designs of hose couplings currently available for various types of hose connection applications. For applications involving routing or bending of a hose to connect to another hose or fitting, a bent or elbowed hose coupling may be used on one or both ends of a hose assembly. This may require, however, the hose coupling to be oriented with respect to the other hose or fitting during assembly. This may be difficult and costly.

One example of a hose coupling for connecting two fluid flow lines is disclosed in U.S. Pat. No. 5,547,233 (“the '233 patent”) to Hoegger. The hose coupling disclosed in the '233 patent includes a hydraulic swivel having a male component and a female component. The male component has a male portion and connects to a first fluid flow line, and the female component has a female portion and connects to a second fluid flow line. The male portion of the male component fits within the female portion of the female component such that the male and female components are rotatable with respect to one another.

Many problems and/or disadvantages still exist with the hose couplings and/or hose assemblies. Various embodiments of the present disclosure may solve one or more of the problems and/or disadvantages discussed above.

### SUMMARY

According to one exemplary aspect, the present disclosure is directed to a hose coupling. The hose coupling may include a hose fitting member configured to sealingly engage with a first fluid communication member, a swivel joint comprising a swivel ball seated in a ball bearing, and a tube extending from the hose fitting member to the swivel ball. In some exemplary embodiments, the swivel ball may be configured to swivel inside the ball bearing to allow the tube to rotate with respect to a center of the swivel ball.

Another exemplary aspect of the present disclosure may provide a hose assembly comprising a hose fitting member configured to sealingly engage with a first fluid communication member and a swivel joint comprising a swivel ball seated in a ball bearing. The swivel joint may be configured to sealingly engage with a second fluid communication member. The hose assembly may also include a tube extending from the hose fitting member to the swivel ball and one of the first and second fluid communication members sealingly engaged with either the hose fitting member or the swivel joint. In an exemplary embodiment, the swivel ball may be configured to swivel inside the ball bearing to allow the tube to rotate with respect to a center of the swivel ball.

In still another exemplary aspect, the present disclosure is directed to a method of manufacturing a hose coupling. The method may comprise placing a swivel ball in a mold device comprising a plurality of mold cores defining a cavity around the swivel ball, where the cavity may correspond to a ball bearing configured to swivelly receive the swivel ball. The method may also include injecting a molding material into the cavity, letting the mold material to harden, and removing the plurality of mold cores to release the swivel ball received in the ball bearing.

### BRIEF DESCRIPTION OF THE DRAWINGS

FIG. 1 is a schematic, cross-sectional view of a hose coupling, according to one exemplary embodiment of the present disclosure;

FIG. 2 is a schematic, cross-sectional view of a molding device, illustrating an exemplary method of manufacturing the hose coupling of FIG. 1.

### DETAILED DESCRIPTION

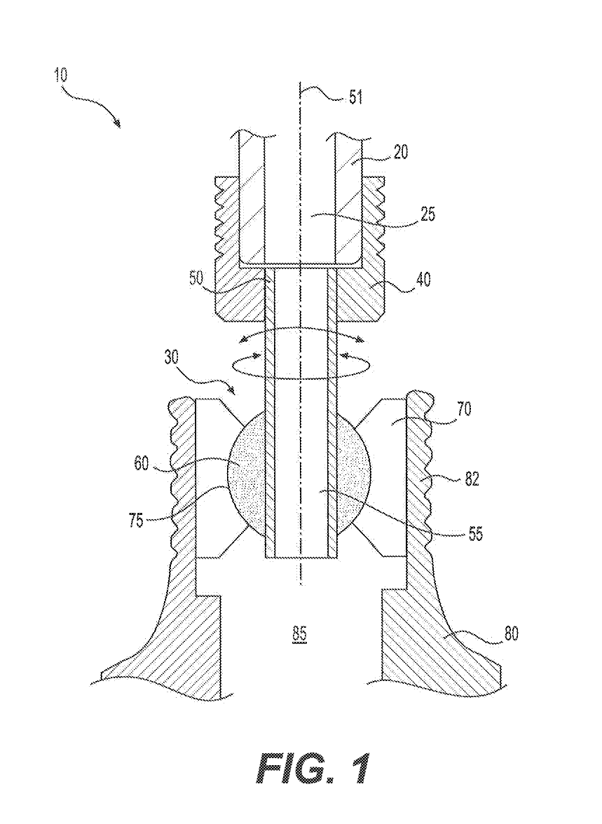

FIG. 1 illustrates a hose coupling 10 for hydraulic connection between a first fluid communication member 20 and a second fluid communication member 80, according to one exemplary embodiment of the present disclosure. In the disclosed embodiment, first fluid communication member 20 may be a hose defining a first flow path 25, and second fluid communication member 80 may be a fluid fitting defining a second flow path 85. While the exemplary embodiments of the present disclosure will be described in connection with a particular hydraulic connection between a hose and a fitting, it should be understood that the present disclosure may be applied to, or used in connection with, virtually any type of hydraulic connections involving two fluid communication members. Further, the term “hose,” as used herein, may refer to any type of hoses, tubes, and pipes typically used in hydraulic applications.

Referring to FIG. 1, hose coupling 10 may include a hose fitting member 40 configured to sealingly engage with first fluid communication member 20, a swivel joint 30 including a swivel ball 60 seated in a ball bearing 70, and a tube 50 extending from hose fitting member 40 to swivel joint 30. Second fluid communication member 80 may wrap around and be connected to swivel joint 30 with its second flow path 85 hydraulically communicating with an interior 55 of tube 50.

Hose fitting member 40 may be a crimp fitting configured to hydraulically connect to first fluid communication member 20 via crimping. Any other fitting arrangement, such as, for example, clamping, swaging, welding, interference-fitting, or threading, can be provided additionally or alternatively.

As mentioned above, tube 50 may extend from hose fitting member 40 to connect with swivel joint 30. One end of tube 50 may be fitted to hose fitting member 40 via any suitable fitting method, such as, for example, welding and threading. In an alternative embodiment, tube 50 and hose fitting member 40 may be integrally formed of unitary construction. The other end of tube 50 may be fitted to swivel ball 60 seated in ball bearing 70.

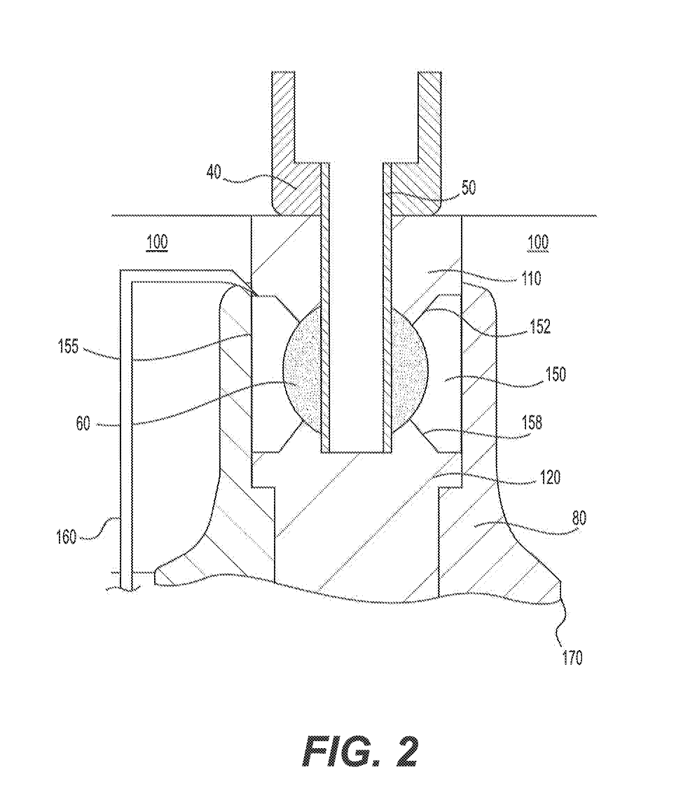

Swivel ball 60 may be made of a suitable metallic material, such as, for example, steel, stainless steel, brass, aluminum, and any alloys thereof. In some exemplary embodiments, swivel ball 60 may be made of a thermosetting or thermoplastic polymer material. Ball bearing 70 may be formed of a suitable molding material that can sustain high pressure of hydraulic fluid and also provide sufficient flexibility for swiveling movement of swivel ball 60 therein. For example, as will be detailed later with reference to FIG. 2, ball bearing 70 may be formed of a suitable thermosetting polymer, such as, polyurethane, which can be injection-molded directly with swivel ball 60. Ball bearing 70 formed of such a thermosetting polymer may exhibit sufficient flexibility to permit swiveling movement of swivel ball 60 inside ball bearing 70 and high-resiliency to sustain high fluid pressure passing through swivel joint 30. In some exemplary embodiments, ball bearing 70 may be formed of a thermoplastic material.

Swivel ball 60 seated in ball bearing 70 may swivel against bearing surface 75 of ball bearing 70 such that, as schematically indicated in FIG. 1, tube 50 fitted with swivel ball 60 can rotate with respect to both a center of swivel ball 60 and a longitudinal axis 51 of tube 50. Accordingly, when a routed or bent hose is to be connected to hose fitting member 40, swivel joint 30 of the present disclosure may orient itself towards the routed or bent hose during installation, thereby eliminating the need for a bent or elbowed coupling and facilitating the installation.

Second fluid communication member 80 may be hydraulically connected to swivel joint 30 via any suitable connection method. For example, as shown in FIG. 1, a distal end 82 of second fluid communication member 80 may wrap around and be crimped to ball bearing 70 of swivel joint 30. When second fluid communication member 80 is connected to swivel joint 30, hose coupling 10 may establish a seal-tight flow communication between first flow path 25 of first fluid communication member 20 and second flow path 85 of second fluid communication member 80 via interior 55 of tube 50.

With reference to FIG. 2, an exemplary method of manufacturing hose coupling 10 of FIG. 1 will be described herein. As briefly mentioned above, ball bearing 70 can be formed by molding a suitable thermosetting or thermoplastic polymer material. While the exemplary manufacturing method will be described in connection with a particular injection-molding process, it should be understood that the present disclosure may be applied to, or used in connection with, any other type of manufacturing processes, including, for example, 3D printing.

Referring to FIG. 2, hose fitting member 40, tube 50, and swivel ball 60 may be pre-assembled as a unit prior to being placed in a suitable molding device 100. Molding device 100 may include at least one stationary support plate and at least one moveable support plate (not shown), and assembled hose fitting member 40, tube 50, and swivel ball 60 may be mounted together between the stationary and moveable support plates. Molding device 100 may include an access opening 170 for receiving distal end 82 of second fluid communication member 80. Molding device 100 may also include an upper mold core 110 and a lower mold core 120, which, together with second fluid communication member 80, may define a cavity 150 corresponding to ball bearing 70. The number and configuration of the mold cores may vary, depending upon, for example, the shape and size of ball bearing 70.

As shown in FIG. 2, upper mold core 110 may be placed between hose fitting member 40 and swivel ball 60 to define an upper surface 152 of cavity 150, and lower mold core 120 may be placed under swivel ball 60 to define a lower surface 158 of cavity 150. Distal end 82 of second fluid communication member 80 may wrap around at least a portion of each of upper and lower mold cores 110 and 120 to define a side surface 155 of cavity 150. In some exemplary embodiments, distal end 82 of second fluid communication member 80 may be threaded onto access opening 170 and/or either or both of upper and lower mold cores 110 and 120. In some exemplary embodiments, second fluid communication member 80 may be replaced with a tubular mold core (not shown). In that case, second fluid communication member 80 may be inserted into access opening 170 after ball bearing 70 is formed and the tubular mold core is removed.

Once cavity 150 is formed by upper mold core 110, lower mold core 120, and distal end 82 of second fluid communication member 80, a suitable molding material, such as, a thermosetting or thermoplastic polymer, may be injected into cavity 150 through a runner pipe 160 formed in molding device 100. Runner pipe 160 may be routed through at least one of upper mold core 110 and lower mold core 120. The molding material inside cavity 150 may become hardened to form ball bearing 70. Once ball bearing 70 is formed, upper mold core 110 and lower mold core 120 are removed to form hose coupling 10 of FIG. 1. Subsequently, distal end 82 of second fluid communication member 80 can be fitted (e.g., crimped) with ball bearing 70 of swivel joint 30 to form a hose assembly.

### INDUSTRIAL APPLICABILITY

The disclosed hose coupling may be applicable to various hose assemblies used for hydraulic connection between two fluid communication members. When applied to connection applications involving a routed or bent hose, the hose coupling according to the present disclosure may eliminate the need for a bent or elbowed coupling, thereby facilitating the installation thereof.

As shown in FIG. 1, hose coupling 10 of the present disclosure may include hose fitting member 40 configured to sealingly engage with first fluid communication member 20, swivel joint 30 having swivel ball 60 seated in ball bearing 70, and tube 50 extending from hose fitting member 40 to swivel joint 30. Swivel ball 60 may swivel inside ball bearing 70, such that tube 50 fitted with swivel ball 60 can rotate with respect to both the center of swivel ball 60 and longitudinal axis 51 (which may coincide with the center of swivel ball 60) of tube 50.

To form a hose assembly with hose coupling 10, at least one of first fluid communication member 20 and second fluid communication member 80 may be engaged with hose fitting member 40 and swivel joint 30, respectively. Accordingly, when a routed or bent hose is to be connected to the hose assembly, swivel joint 30 of the present disclosure may allow either hose fitting member 40 or swivel joint 30 to orient itself towards the routed or bent hose during installation, thereby eliminating the need for a bent or elbowed coupling and facilitating the installation.

It will be apparent to those skilled in the art that various modifications and variations can be made to the disclosed hose couplings and hose assemblies. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A hose coupling comprising:
a hose fitting member configured to sealingly engage with a first fluid communication member;
a swivel joint comprising a swivel ball seated in a ball bearing; and
a tube extending from the hose fitting member to the swivel ball,
wherein the swivel ball is configured to swivel inside the ball bearing to allow the tube to rotate with respect to a center of the swivel ball.

2. The hose coupling of claim 1, wherein the tube is rotatable with respect to a longitudinal axis of the tube.

3. The hose coupling of claim 1, wherein the swivel joint is configured to sealingly engage with a second fluid communication member.

4. The hose coupling of claim 3, wherein the tube defines an interior in fluid communication between the first fluid communication member and the second fluid communication member.

5. The hose coupling of claim 1, wherein the hose fitting member comprises a crimp fitting.

6. The hose coupling of claim 1, wherein the ball bearing comprises a thermosetting polymer material.

7. The hose coupling of claim 6, wherein the thermosetting polymer material comprises polyurethane.

8. A hose assembly comprising:
a hose fitting member configured to sealingly engage with a first fluid communication member;
a swivel joint comprising a swivel ball seated in a ball bearing, the swivel joint being configured to sealingly engage with a second fluid communication member;
a tube extending from the hose fitting member to the swivel ball; and
one of the first and second fluid communication members sealingly engaged with either the hose fitting member or the swivel joint,
wherein the swivel ball is configured to swivel inside the ball bearing to allow the tube to rotate with respect to a center of the swivel ball.

9. The hose assembly of claim 8, wherein the tube is rotatable with respect to a longitudinal axis of the tube.

10. The hose assembly of claim 8, wherein the tube defines an interior in fluid communication between the first fluid communication member and the second fluid communication member.

11. The hose assembly of claim 8, wherein the hose fitting member comprises a crimp fitting.

12. The hose assembly of claim 8, wherein the ball bearing comprises a thermosetting polymer material.

13. The hose assembly of claim 12, wherein the thermosetting polymer material comprises polyurethane.

14. The hose assembly of claim 8, wherein the swivel joint is receivable inside the second fluid communication member.

15. A method of manufacturing a hose coupling, comprising:
placing a swivel ball in a mold device comprising a plurality of mold cores that define at least a portion of a cavity around the swivel ball, the cavity corresponding to a ball bearing configured to swivelly receive the swivel ball;
injecting a molding material into the cavity;
letting the mold material to harden; and
removing the plurality of mold cores to release the swivel ball received in the ball bearing.

16. The method of claim 15, wherein placing the swivel ball comprises:
fitting a tube extended from a hose fitting member configured to connect to a fluid communication member; and
placing the swivel ball in the mold device with the tube fitted therein.

17. The method of claim 15, further comprising placing a fluid communication member around the swivel ball, wherein the plurality of mold cores and the fluid communication member cooperatively define the cavity.

18. The method of claim 17, wherein the plurality of mold cores comprises an upper mold core defining an upper surface of the cavity and a lower mold core defining a lower surface of the cavity, and wherein the fluid communication member defines a side surface of the cavity.

19. The method of claim 15, wherein the molding material comprises a thermosetting polymer material.

20. The method of claim 19, wherein the thermosetting polymer material comprises polyurethane.
